(19) United States
(12) Patent Application Publication
(10) Pub. No.: US 2023/0161912 A1
(43) Pub. Date: May 25, 2023

(54) SYSTEM, METHOD, AND DEVICE FOR PROVIDING MULTIPLE SOFTWARE RESOURCES

(71) Applicant: CloudOps Inc., Montreal (CA)

(72) Inventors: Patrick Dubé, Montreal (CA); Simon Godard-Tremblay, Sainte-Marthe-sur-le-lac (CA); Franz Garcia, Montreal (CA); Marc Vaillancourt, Boucherville (CA)

(73) Assignee: CloudOps Inc., Montreal, QC (CA)

(21) Appl. No.: 17/980,876

(22) Filed: Nov. 4, 2022

Related U.S. Application Data
(60) Provisional application No. 63/276,269, filed on Nov. 5, 2021.

(51) Int. Cl. G06F 21/62; G06F 9/445; G06F 9/54

(52) U.S. Cl. CPC G06F 21/629; G06F 9/44526; G06F 9/541

(57) ABSTRACT

Provided are systems, methods, and platforms for providing software resources. The system includes a first-level provider device providing a software resource and a provisioning platform including a provisioning module for interacting with the first-level provider device to gain access to the software resource, a permissions module for providing the software resource to an end user device and user according to tenant permissions data, and a management module for managing access to the software resource using dynamically generated APIs as enabled by software plugins for connecting the provisioning module and first-level provider device, and the end user device for interacting with the provisioning platform in order to gain access to the software resource.

### TECHNICAL FIELD

The following relates generally to providing users with multiple software resources through an organizational client and more particularly to offering tailored software resources to business units through software plugins.

### INTRODUCTION

Providers of software resources are often unable or unwilling to manage allocation of the software resources to end user devices as well as to allow for customization of some or all of the software resources, for example, cloud computing and/or cloud storage (i.e., distributed, passive, on-demand computing and/or storage). Similarly, many such end user devices lack a technical sophistication appropriate to manage resources on backend systems. Even where providers and/or users may be desirous of such allocation, new software resources become readily available and would involve continual effort by the providers and users to integrate into existing frameworks and networks.

Providing software resources to different users represents a complex functionality that is often desired by the providers and users in order to achieve the full benefits of the software resources but is often outside the expertise of the providers and users.

The present disclosure offers computer solutions for allowing users to manage resources on backend systems through dynamically generated APIs. User identity and permissions may advantageously be automatically managed and user resources rendered easy to set up and secure to maintain. The use of software plugins and SDKs to connect different software resources together and to provide users therewith may advantageously facilitate increasing automation. Accordingly, additions and alterations to the multiple software resources may be dynamically effected through a single platform without available software resources and the providers thereof having to be defined in advance.

The present disclosure further offers functionality for accessing and provisioning multiple software resources through a single platform. The provisioning platform may advantageously permit software resource providers to pick and choose different components to offer to end user devices. The provisioning platform may further advantageously enable intermediate providers and resellers to repackage software resources to end user devices to support further customization.

Accessing and provisioning multiple software resources through a single platform may advantageously increase computer security, reduce computer processing, and improve computer efficiency.

### SUMMARY

A system for providing software resources is provided. The system includes a first-level provider device that provides a software resource and a provisioning platform. The provisioning platform includes a resource provisioning module for interacting with the first-level provider device in order to gain access to the software resource, a permissions module configured to provide the software resource to an end user device according to tenant permissions data of the end user device and provide the software resource to a user of the end user device according to tenant permissions data of the user of the end user device, a management module for managing access to the software resource using dynamically generated application programming interfaces (APIs) as enabled by software plugins for connecting the resource provisioning module and the first-level provider device, and the end user device for interacting with the provisioning platform in order to gain access to the software resource.

The system may further include an intermediate-level provider device to which the first-level provider device provides the software resource through the provisioning platform and from which the end user device gains access to the software resource through the provisioning platform.

Each end user device may provide tenant permissions data for determining whether each user of the end user device may access the data.

The resource provisioning module may create an account with the first-level provider device.

The end user device may access the software resource through the account.

It may be the case that the end user device only accesses the account with the first-level provider device through the provisioning platform.

The resource provisioning module may create a unique account with the first-level provider device for each user of the end user device.

The resource provisioning module may use the same account for each user of the end user device.

The system may include identity module for assigning tenant identity data to each user of each end user device specific to the software resource to which the user has access.

The first-level provider device may use the provisioning platform to manage the tenant identity data of each user of each end user device.

The first-level provider device may select the software resource from among multiple software resources.

A method for providing software resources is provided. The method includes providing a software resource from a first-level provider device, a provisioning platform gaining access to the software resource through the first-level provider device, providing the software resource to an end user device according to tenant permissions data of the end user device, providing the software resource to a user of the end user device according to tenant permissions data of the user of the end user device, and managing access to the software resource using dynamically generated APIs as enabled by software plugins for connecting the provisioning platform and the first-level provider device.

The method may further include the permissions module providing the software resource from the first first-level provider device to an intermediate-level provider device and from the intermediate-level provider device to the end user device.

The method may further include providing tenant permissions data for determining whether each user of the end user device may access the data.

The method may further includes the provisioning platform creating an account with the first-level provider device.

The end user device may access the software resource through the account.

It may be the case that the end user device only accesses the account with the first-level provider device through the provisioning platform.

The method may further include the provisioning platform creating a unique account with the first-level provider device for each user of the end user device.

The method may further include using the same account for each user of the end user device.

The method may further include assigning tenant identity data to each user of each end user device specific to the software resource to which the user has access.

The method may further include managing the tenant identity data of each user of each end user device.

The method may further include selecting the software resource from among multiple software resources.

A provisioning platform for providing software resources is provided. The platform includes a resource provisioning module for interacting with a first-level provider device in order to gain access to the software resource, a permissions module configured to provide the software resource to an end user device according to tenant permissions data of the end user device and provide the software resource to a user of the end user device according to tenant permissions data of the user of the end user device, and a management module for managing resources using dynamically generated application programming interfaces (APIs) as enabled by software plugins for connecting the resource provisioning module and the first-level provider device.

The resource provisioning module may provide the software resource from the first-level provider device to an intermediate-level provider device and from the intermediate-level provider device to the end user device.

Each end user device may provide tenant permissions data for determining whether each user of the end user device may access the data.

The resource provisioning module may create an account with the first-level provider device.

The end user device may access the software resource through the account.

It may be the case that the end user device only accesses the account with the first-level provider device through the provisioning platform.

The resource provisioning module may create a unique account with the first-level provider device for each user of the end user device.

The resource provisioning module may use the same account for each user of the end user device.

The platform may further include an identity module for assigning tenant identity data to each user of each end user device specific to the software resource to which the user has access.

The first-level provider device may use the provisioning platform to manage the tenant identity data of each user of each end user device.

The first-level provider device may select the software resource from among multiple software resources.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for accessing and provisioning multiple software resources through a single platform, according to an embodiment;

FIG. 2 is a block diagram of a computing device of the present disclosure, according to an embodiment;

FIG. 3A is a block diagram of a multi-level, multi-tenant hierarchy after software resources are provided through the single platform, according to an embodiment;

FIG. 3B is a block diagram of the multi-level, multi-tenant hierarchy of FIG. 3A from the point of view of an end user device of the provided software resources;

FIG. 4A is a block diagram of a computer system for implementing a multi-level, multi-level hierarchy, according to an embodiment;

FIG. 4B is a schematic view of the computer system of FIG. 4A;

FIG. 5 is a flow chart of a method for providing software resources, according to an embodiment;

FIG. 6 is a flow chart of a method for providing software resources, according to an embodiment;

FIG. 7 is a flow chart of a method for providing software resources, according to an embodiment;

FIG. 8 is a view of an environment after implementation of the multi-level, multi-tenant hierarchy of FIG. 3A, according to an embodiment;

FIG. 9 is a view of the environment of FIG. 8 upon creation thereof;

FIG. 10 is a view of the environment of FIG. 8, upon adding members thereto;

FIG. 11 is a view of the environment of FIG. 8, upon initialization thereof;

FIG. 12 is a view of the organizational structure of a lower-level client device of the multi-level, multi-tenant hierarchy of FIG. 3A, according to an embodiment;

FIG. 13 is a chart of an organizational structure of several lower-level client devices of FIG. 3A; and

FIG. 14 is a view of the provision of software resources.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

While the present disclosure describes the invention in the context of providing and provisioning software resources (including data storage and cloud computing), the systems, methods, and devices provided herein may have further applications and different uses beyond those described herein, whether in the context of software resources or otherwise (e.g. software resources associated with physical commodities and software resources). Multi-level, multi-tenant relationships described herein, whether called multi-level, multi-tenant, or otherwise, may in other embodiments be other relationships susceptible to hierarchies.

The following relates generally to provisioning software resources, and more particularly to multi-level, multi-tenant hierarchies of same. The present disclosure provides systems, methods, and devices for provisioning software resources to organizations and end user devices of such organizations in order to achieve automatic identity validation and credentialing as users and ownership of data change.

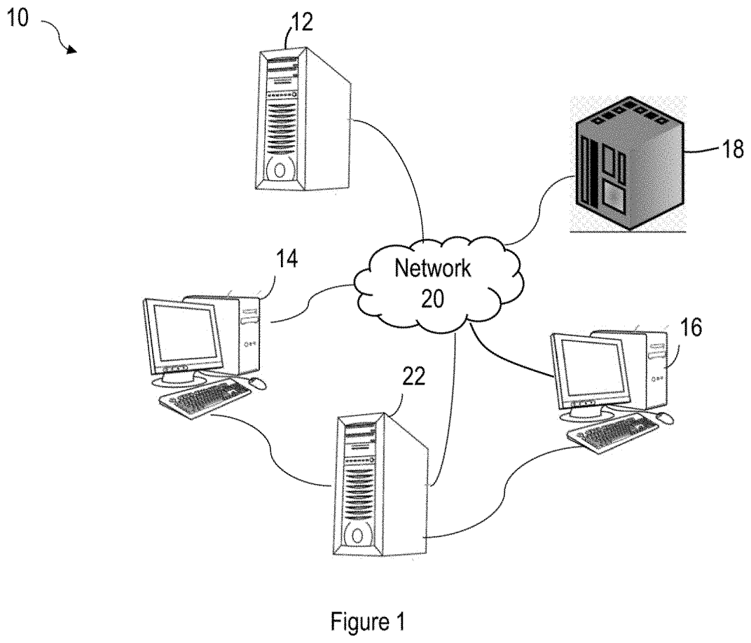

Referring now to FIG. 1, shown therein is an automated provisioning system 10 for enabling a multi-level, multi-tenant hierarchy, in accordance with an embodiment. Throughout the disclosure, “multi-level, multi-tenant” is understood to refer to hierarchical and/or permission-based relationships pertaining to access to data or other confidential information, ownership of software resources, receipt of software resources, and the provisioning of any of the relationships among tenants and/or levels.

The system 10 includes a first-level provider device 12 for providing one or more software resources, for example cloud computing and associated storage (i.e., distributed, passive, on-demand computing and/or storage). The software resources may include any software resources to which network access is provided and which have an API available to manage the software resources. In an embodiment, the first-level provider device 12 may be provided by a company providing software, on a downloadable basis, SaaS basis, or otherwise, data, algorithms, or the like. In an embodiment, the first-level provider device 12 may be a computing device or system of computing devices that provides software software resources.

The system 10 includes an intermediate-level provider device 22 for receiving the one or more software resources and further providing software resources to first and second end user devices 14, 16. In an embodiment, the intermediate-level provider device 22 may provide software, on a downloadable basis, SaaS basis, or otherwise, data, algorithms, or the like. In an embodiment, the intermediate-level provider device 22 may be a computing device or system of computing devices that provides software resources and/or creates software resources.

In an embodiment, the intermediate-level provider device 22 provides to the end user devices 14, 16 the same software resources as provided by the first-level provider device 12. In an embodiment, the intermediate-level provider device 22 provides to the end user devices 14, 16 only a subset of the software resources as provided by the first-level provider device 12. The intermediate-level provider device 22 may create and provide further software resources to the end user devices 14, 16, in addition to or instead of the software resources of the first-level provider device 12. The intermediate-level provider device 22 may customize or further alter the software resources as provided by the first-level provider device 12 before providing the software resources to the end user devices 14, 16. In an embodiment, the intermediate-level provider device 22 integrates functionality across software resources from multiple first-level provider devices 12 before providing the software resources to the end user devices 14, 16.

Each of the first and second end user devices 14, 16 may desire access to the software resources, but it may not be efficient, possible, or desirable for each end user device to individually interact with the first-level provider device 12 and/or intermediate-level provider device 22 in order to arrange for same. In an embodiment, the end user devices 14, 16 may be any of smartphones, computers, laptop computers, tablets, smartwatches, or other smart devices.

The system 10 further includes a provisioning platform 18 for implementing a multi-level, multi-tenant hierarchy and relationship between and among the first-level provider device 12, the intermediate-level provider device 22, and the end user devices 14, 16.

Throughout the disclosure, “multi-level, multi-tenant” is understood to refer to hierarchical and/or permission-based relationships pertaining to access to data or other confidential information, ownership of software resources, receipt of software resources, and the provisioning of any of the relationships.

A multi-level relationship is one where software resources are initially provided by a first party 12 and may further be provided by a second party 22. Such further provisioning may occur on a different basis than provided by the first party 12. For example, the second party 22 may offer accounts (or other forms of identities or credentials) and project-based data storage to organize end user device data, such accounts and data storage not being provided by the first party 12. Such accounts (or other forms of identities or credentials) may be specific to each software resource so provided. A multi-level relationship is to be understood as encompassing any number of levels beyond the first party 12. For example, a third party (not shown) may further provide the software resources as provided by the second party 22 (which were initially provided by the first party 12), a fourth party (not shown) may further provide the software resources as provided by the third party, and so forth. Each subsequent party may add additional functionality to the software resources, may provide the software resources on different bases, or may simply provide the software resources to a further party “as is”.

Where multi-level and/or multi-tenant relationships are supported by a party (such as the first party 12), the multi-level, multi-tenant hierarchy of the present disclosure may use or otherwise incorporate existing relationship support.

Where permissions, storage, and other provisioning tools such as accounts are supported by a party, the multi-level, multi-tenant hierarchy of the present disclosure may use or otherwise incorporate existing provisioning tools. Accordingly, there may be a 1:1 match between a software resource as provided by a provider and an account for access thereto, and an account or representation thereof as enabled by the provisioning platform 318. In an embodiment, an end user device only sees the account or representation thereof as enabled by the provisioning platform 318.

Throughout the disclosure, “user” is understood to refer to a user of software resources as herein described, whether related organizations, divisions within an organization, customers, or end user devices of the organization. Where a more restricted use of the term “user” is appropriate (for example, “end user device”), same will be provided.

A multi-tenant relationship is one where multiple users may each generally access software resources or a subset thereof, for example as provided to a level of a multi-level relationship, but such access is provided in a fashion specific to each user. Access to the software resources may be provided granularly, i.e., where a software resource does not support multiple tenancy, the software resource may be provided on an individualized basis to each user. Accordingly, the provider that grants resources may be responsible for keeping access to data separate among users. Such access may occur through the end user devices 14, 16. In an embodiment, a user within a multi-tenant relationship may not view, access, alter, change, copy, download, etc. any data provided by or pertaining to another user. For example, each user may have a specific account associated with the user, and the contents of the account and further information associated therewith are kept private from other users. Where the provider does not support such individualized accounts, the provisioning platform 18 may configure such accounts locally and mediate and govern all access to the software resources by the users according to the localized accounts. A multi-tenant relationship is to be understood as encompassing any number of tenants beyond a first tenant.

In a multi-level, multi-tenant relationship, multiple levels within the relationship may exist as hereinbefore described, and multiple tenants may be present on each level. In an embodiment, one or more first parties 12 provides software resources to multiple second parties 22, who in turn provide the software resources to multiple third parties (not shown), etc. Accordingly, multiple tenants may be present in one or more of the multiple levels.

In an embodiment, a user is able to access and/or alter any data pertaining to any users “below” the user in the multi-level, multi-tenant relationship. In an aspect, a user is only able to so access and/or alter the data of users directly “below” the user. For example, an organization may be able to access or alter any data viewed or used by any employee, contractor, agent, or the like of the organization. Where organizations on the same level are related, each organization may be able to access and alter the data of the organization's own users “below” the organization but may only be able to access (and not alter) data of users “below” related organizations.

In a multi-level, multi-tenant relationship, parties and users as described herein may or may not be aware of the existence of multiple levels and/or multiple tenants. For example, a first party 12 providing software resources may be aware that the first party 12 is providing same to a second party 22 but may not be aware that the second party 22 is provisioning same to one or more third parties (not shown). Similarly, the second party 22 may or may not be aware that the third party is provisioning the software resources provided by the second party 22 to one or more fourth parties (not shown). Similarly, users may not be aware of the existence of other users as tenants. For example, one or more employees of an organization may each consider that they have their own account with a resource as provided by their organization. In reality, each employee may use the same account provided by a first party 12 through the organization. In an aspect, the software resource as provided by the employer may contain further data rules or black-boxing in order to prevent either employee from accessing or altering data viewed or provided by the other employee. Such an arrangement may exist even where the first party 12 originally providing such a resource is not aware that more than one user has access to a single account with the first party 12 and further is not aware of any need to keep data separate as between users. Because of the multi-level, multi-tenant relationship, the first party 12 does not need to be informed of such further relationships and/or structure.

In an embodiment, the end user devices 14, 16 receive the software resources from the intermediate-level provider device 22 as though the intermediate-level provider device 22 were the first-level provider device 12.

In an embodiment, the first-level provider device 12 provides the software resources to the intermediate-level provider device 22 as though the intermediate-level provider device 22 were each of the end user devices 14, 16.

In an embodiment, each provider or user within the system 10 is not aware of any other providers or users within the system 10. The provisioning platform 18 acts interstitially between each provider and user as a backend in order to support an anonymous or pseudo-anonymous multi-level, multi-tenant relationship structure.

In an embodiment, the first-level provider device 12 represents multiple first-level provider devices, each of which offer different software resources. The provisioning platform 18 interacts with the multiple first-level provider devices 12 and coordinates the different software resources so that all the software resources may be provided through a single point. For example, the provisioning platform 18 may provide all the software resources to which a user has subscribed through a single subscription point, e.g., a website. The provisioning platform 18 may select only certain software resources from across the multiple first-level provider devices 12 in order to provide a unique package of software resources to intermediate-level provider devices 22 and/or end user devices 14, 16 not otherwise available to such providers 22 and devices 14, 16.

Advantageously and through operation of the provisioning platform 18, each of the end user devices 14, 16 may only need to interact with the intermediate-level provider device 22 in order to gain access to and make regular use of the software resources of the multiple first-level provider devices 12. Similarly, the intermediate-level provider device 22 may only need to interact with the provisioning platform 18 in order to gain access to and make regular use of the software resources of the multiple first-level provider devices 12. Such coordination may be achieved dynamically through the use of governance APIs and plugin SDKs. The plugin SDKs advantageously allow interfaces to manage particularities of multi-tenancy on backends of each software resource provided. Such plugins may be designed by contract with third parties. Through the use of plugins, core elements of the systems, methods, and devices disclosed herein may operate without integrating software resources in advance of operation, i.e., software resources may be integrated and provided later and on an ad hoc basis. Every time a new software resource is added, a new plugin may be created therefor. The plugin SDK defines an interface for plugins to expose different resources and operations as supported by a backend service. The plugin may have an appearance (e.g., a user interface) defined therein to specify how resources and operations made available through the plugin may appear. Further features may be provided with associated defined interfaces to allow incorporation in plugins, e.g., usage tracking and pricing, metric collection, quotas. For example, the devices 14, 16 may make API requests to dynamic APIs of first-level provider devices 12 and/or intermediate-level provider devices 22 through the provisioning platform 18. Users of the devices 14, 16 may not be aware that the devices 14, 16 are making such requests through the provisioning platform 18 of other levels of the system 10.

In an embodiment, the plugin SDKs are associated with a mapping to an environment. Such plugin SDKs include a concept of an owner of a group of software resources and automate the creation thereof. The plugin SDKs abstract a means for multiple organizations with different sets of resources to isolate those resources and to hide the resultant complexity from users.

In an embodiment, there may be multiple intermediate-level provider devices 22 in addition to or instead of the multiple first-level provider devices 12. According to the software resource needs and preferences of the end user devices 14, 16, the provisioning platform 18 allows for access and continued use through a single point in order to increase efficiency of computer operations and reduce computer processing.

In an embodiment, the provisioning platform 18 allows the providers 12, 22 and devices 14, 16 to manage resources by acting as a backend system through dynamically generated APIs. As such APIs are dynamically generated for the software resources providers 12, 22, the provisioning platform 18 is not required to already have applicable communication protocols, software code, etc. to interact with a particular provider 12, 22 in advance nor with a backend thereof. Accordingly, the provisioning platform 18 and associated system 10 may provide a modularity in operation through allowing the introduction and/or substitution of different software resources just as the provisioning platform 18 and system 10 provide flexibility to the devices 14, 16.

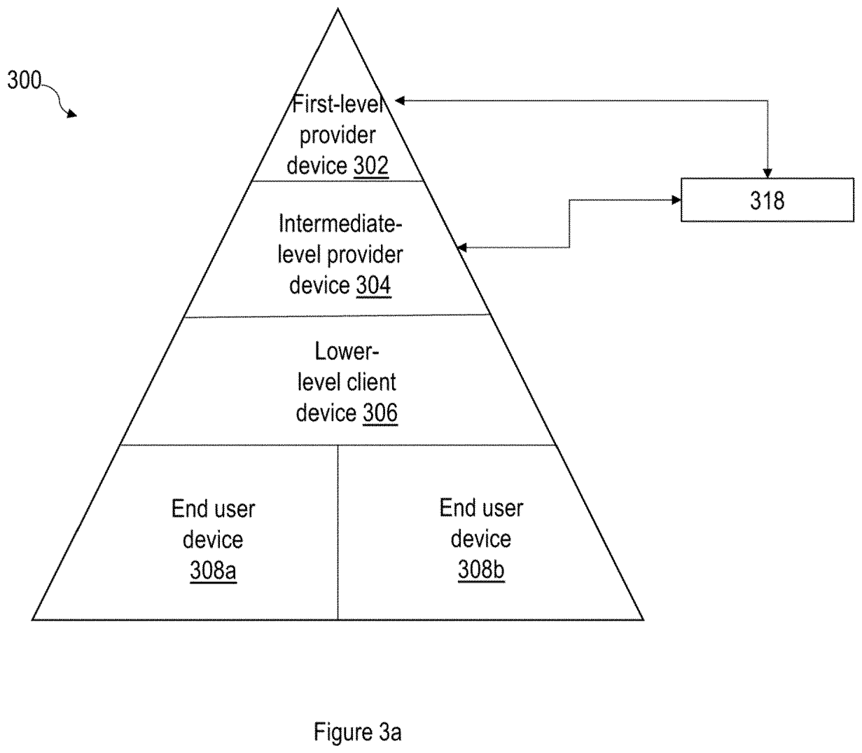

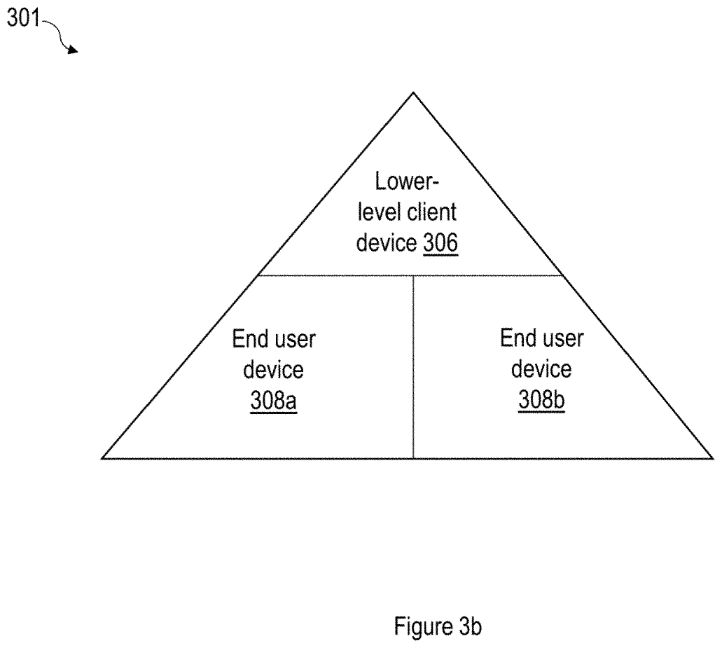

Plugin software development kits (SDKs) may further act as metadata defining the relationships of the first-level provider device 12, the intermediate-level provider device 22, the end user devices 14, 16, and the provisioning platform 18 and an organizational hierarchy therefor. The organization hierarchy refers to a direction in which software resources flow as further shown in FIGS. 3A, 3B.

The provisioning platform 18 may use the metadata to create document and data mappings from higher levels to lower levels and back within a multi-level, multi-tenant hierarchy. The provisioning platform 18 may integrate new first-level provider devices 12, new intermediate-level provider devices 22, and the associated software resources into an already existing multi-level, multi-tenant hierarchy as in the system 10.

The providers 12, 22, devices 14, 16, and/or platform 18 may be a server computer, node computing device, embedded device, desktop computer, notebook computer, tablet, PDA, smartphone, or another computing device. The providers 12, 22, devices 14, 16, and/or platform 18 may include a connection with the network 20 such as a wired or wireless connection to the Internet. In some cases, the network 20 may include other types of computer or telecommunication networks. The providers 12, 22, devices 14, 16, and/or platform 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20.

Input device may include any device for entering information into the providers 12, 22, devices 14, 16, and/or platform 18. For example, input device may be a keyboard, keypad, cursor-control device, touchscreen, camera, or microphone. Display device may include any type of device for presenting visual information. For example, display device may be a computer monitor, a flat-screen display, a projector, or a display panel. Output device may include any type of device for presenting a hard copy of information, such as a printer for example. Output device may also include other types of output devices such as speakers, for example. In some cases, the providers 12, 22, devices 14, 16, and/or platform 18 may include multiple of any one or more of processors, applications, software modules, second storage devices, network connections, input devices, output devices, and display devices.

Although the providers 12, 22, devices 14, 16, and/or platform 18 are described with various components, one skilled in the art will appreciate that the providers 12, 22, devices 14, 16, and/or platform 18 may in some cases contain fewer, additional or different components. In addition, although aspects of an implementation of the providers 12, 22, devices 14, 16, and/or platform 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the providers 12, 22, devices 14, 16, and/or platform 18 and/or processor to perform a particular method.

The providers 12, 22, devices 14, 16, and/or platform 18 may be described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, it is described below that the providers 12, 22, devices 14, 16, and/or platform 18 may send information to one or more other of the providers 12, 22, devices 14, 16, and/or platform 18. For example, a user using the end user device 14, 16 may manipulate one or more inputs (e.g., a mouse and a keyboard) to interact with a user interface displayed on a display of the end user device 14, 16. Generally, the device may receive a user interface from the network 20 (e.g., in the form of a webpage). Alternatively, or in addition, a user interface may be stored locally at a device (e.g., a cache of a webpage or a mobile application).

The providers 12, 22, devices 14, 16, and/or platform 18 may be configured to receive a plurality of information, from one or more of the plurality of providers 12, 22, devices 14, 16, and/or platform 18.

In response to receiving information, the respective providers 12, 22, devices 14, 16, and/or platform 18 may store the information in storage database. The storage may correspond with secondary storage of one or more of the providers 12, 22, devices 14, 16, and/or platform 18. Generally, the storage database may be any suitable storage device such as a hard disk drive, a solid-state drive, a memory card, or a disk (e.g., CD, DVD, or Blu-ray etc.). Also, the storage database may be locally connected with the providers 12, 22, devices 14, 16, and/or platform 18. In some cases, storage database may be located remotely from the providers 12, 22, devices 14, 16, and/or platform 18 and accessible to the providers 12, 22, devices 14, 16, and/or platform 18 across a network for example. In some cases, storage database may comprise one or more storage devices located at a networked cloud storage provider.

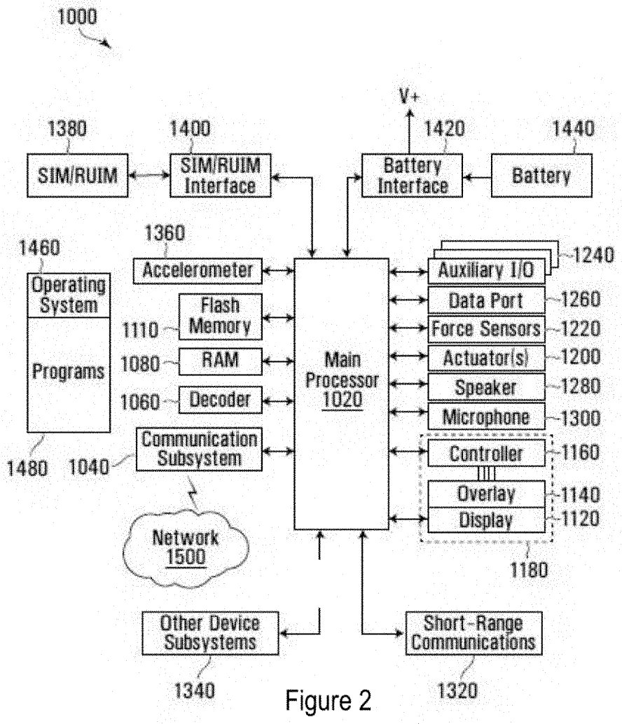

Referring now to FIG. 2, shown therein is a block diagram of a computing device 1000 of the system 10 of FIG. 1, according to an embodiment. The computing device 1000 may be, for example, any one of the providers 12, 22, devices 14, 16, and/or platform 18 of FIG. 1.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 through the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

Referring now to FIG. 3A, shown therein is a block diagram showing a hierarchy 300 of the multi-level, multi-tenant relationships of the system 10 of FIG. 1, according to an embodiment. The hierarchy 300 governs how software resources flow from one level to another level. The hierarchy 300 further determines which data may be accessed or altered by which tenants.

A first-level provider device 302 makes available software resources. In an embodiment, the software resources may include cloud computing and the resources may include cloud storage.

The first-level provider device 302 is communicatively connected to a provisioning platform 318 for provisioning at least some of the software resources of the first-level provider device 302. The provisioning platform 318 may select a subset of the software resources of the first-level provider device 302 according to needs and/or preferences of an intermediate-level provider device 304.

The intermediate-level provider device 304 may be a reseller or retail provider of software resources. The intermediate-level provider device 304 is communicatively connected to the provisioning platform 18 for receiving the provided software resources of the first-level provider device 302. The intermediate-level provider device 304 may provide software resources of the intermediate-level provider device 304 in addition to the software resources received through the provisioning platform 318. The intermediate-level provider device 304 further makes available software resources (any combination or subcombination of the software resources of the intermediate-level provider device 304 and the software resources received from the first-level provider device 302) to a lower-level client device 306 through the provisioning platform 318.

The lower-level client device 306 may be an organization that uses the software resources made available through the system 10 for business purposes of the lower-level client device 306.

The lower-level client device 306 may provide software resources to end user devices 308a, 308b (referred to collectively as the end user devices 308). The end user devices 308 may be employees, contractors, agents, etc. of the lower-level client device 306. The lower-level client device may provide access as needed according to projects or tasks of the end user devices 308. For reasons of internal security, business confidentiality, etc., each of the end user devices 308 may not be able to view or access operations performed or data viewed or altered by another end user device 308.

Each of the first-level provider device 302, the intermediate-level provider device 304, the lower-level client device 306, and the end user devices 308 may be understood as tenants at a particular level within the hierarchy. Where multiple tenants are at the same level of the hierarchy (e.g., the end user devices 308), the level may be understood as a multi-tenant level. A multi-level hierarchy where levels support multiple tenants (i.e., are multi-tenant) may be understood as a multi-level, multi-tenant hierarchy (e.g., the multi-level, multi-tenant hierarchy 300).

The lower-level client device 306 may govern resources to the end user devices 308 through the provisioning platform 318. That is, the lower-level client device 306 may communicate directly with the provisioning platform 318. The end user devices 308 may have no direct communication with the provisioning platform 318. Accordingly, the end user devices 308 may make all communications and requests concerning software resources through the lower-level client device 306 (e.g., their employer).

The end user devices 308 may be able to communicate with the provisioning platform 318 directly and may be able to make any communications and requests concerning software resources without involving the lower-level client device 306 (for example, where the end user devices 308 are partners within an enterprise 306).

The hierarchy 300 of the system 10 may be self-similar, that is, the relationship between a “higher” provider and “lower” provider may be analogous to the relationship between a provider and a consumer of software resources, e.g., 302:304::304:306.

Each level of the hierarchy 300 may be able to view all operations performed and data accessed or altered by a lower level on the hierarchy 300. Each level of the hierarchy 300 may be able to view all operations performed and data accessed or altered by a tenant.

It will be appreciated that there may be more levels in a multi-level, multi-tenant hierarchy than are shown in FIG. 3a.

It will be appreciated that each level of the hierarchy 300 may include additional tenants beyond the tenants shown. For example, there may be multiple first-level provider devices 302a, 302b, etc.; multiple intermediate-level provider devices 304a, 304b, etc.; multiple lower-level client devices 306a, 306b, etc.; and further end user devices 308c, 308d, etc.

The provisioning platform 318 may enforce scoping and/or mandatory access control. Each level of the hierarchy 300 may be able to view all operations performed and data accessed or altered by a lower level on the hierarchy 300. Each tenant of each level of the hierarchy 300 may be able to view or alter all operations performed and data accessed or altered by other tenants of the same or a lower level of the hierarchy 300. Each tenant of each level of the hierarchy may be able to view or alter only the operations performed and data accessed by the particular tenant; for example, the activities and data of the end user device 308a may not be viewed or altered by other tenants and levels and may be known only to the provisioning platform 318.

In an embodiment, where software resources of a higher level of the hierarchy 300 are not partitioned, differentiated, divided, or provided by a tenant of the higher level (e.g., the first-level provider device 302), the provisioning platform 318 provides such further structure. For example, rather than create an account for each end user device 308a with the first-level provider device 302, the provisioning platform 318 may create “dummy” accounts on the provisioning platform 318 unique to each end user device 308a that all map to a single “real” account on the first-level provider device 302 managed by the provisioning platform 318. Accordingly, the provisioning platform 318 mediates all interaction between different levels of the hierarchy 300 in order to manage permissions and access to data. For example, the end user devices 308a and 308b may both use and store data on a single “real” account of the first-level software resource provider 302, but neither end user device 308a, 308b may be able to access or alter data of the other such end user device. Furthermore, neither end user device 308a, 308b may be aware of the structure and may particularly not be aware that such end user device 308a, 308b shares a “real” account with the other such end user device 308b, 308a. Accordingly, the hierarchy 300 offers isolation of data generated by and/or pertaining to each end user device. Such isolation may further be implemented as isolation of different tenants on different levels. Such isolation may further be implemented as isolation of different levels.

The providers of software resources may or may not be aware that multiple levels and tenants of the hierarchy 300 exist. In an embodiment, where a provider is so aware, the provider (such as the first-level provider device 302) may facilitate the hierarchy 300 through special approaches to enable the provisioning platform 318, such as through tracking user usage of the software resources.

Where providers in “higher” levels of the hierarchy 300 do offer existing relationship management or data partitioning (e.g., accounts), the provisioning platform 318 may use the existing relationship management or data partitioning in implementing the hierarchy 300.

In an embodiment, the provisioning platform 318 may support plug-in functionality to offer dynamicity in configurations of software resources by providers 302, 304. Governance APIs may be leveraged through back-end software resources of the provisioning platform 318. Accordingly, end user device identity and permissions may be securely managed locally on the provisioning platform 318.

In an embodiment, an intermediate-level provider device 304 may determine a range of software resources to offer to a lower-level client device 306. Once the lower-level client device 306 and the provisioning platform 318 are communicatively connected, the provisioning platform 318 manages customer account creation, customer data retention, and customer identity confirmation automatically (for example, with further software resources provided through the hierarchy 300 or otherwise).

Accordingly, a new end user device 308c (not shown) may be added under the lower-level client device 306. The lower-level client device 306 may instruct the provisioning platform 318 as to which software resources are to be provided to the end user device 308c. Default set-up configurations and preferences may apply instead of or in addition to specific instructions from the lower-level client device 306.

In an embodiment, a software resource provider 302, 304 may create a lower-level tenant through the provisioning platform 318. The software resource provider 302, 304 may assign software resources to the lower-level tenant, and any end user device through the lower-level tenant may be provided with the software resources accordingly.

Referring now to FIG. 3B, shown therein is a block diagram illustrating the experience of the end user devices 308a, 308b in an apparent hierarchy 301. The apparent hierarchy 301 is the hierarchy 300 as perceived by users of the end user devices 308.

In an embodiment, according to their position in the hierarchy 300, the end user devices 308a, 308b do not directly interact with the providers 302, 304, or the provisioning platform 318. All interaction of the end user devices 308 with other levels of the hierarchy 300 is mediated and governed by the lower-level client device 306 and/or the provisioning platform 318.

Depending on the primitives (i.e., component software resources) provided by a provider, multiple tenancy of the end user devices 308 may be supported at a billing level.

Project identity supports the creation of identities within projects for each user thereof as a part of the environment in which the project is localized. As an example, where the end user device 308a has access to 3 projects, the end user device 308a has three accounts created as primitives within the providers of software resources that underpin the projects. The end user device 308a perceives a flattened apparent hierarchy 301 as shown in FIG. 3B and sees only the three projects. Such provided user accounts are secure relative to one another. The mapping between primitive constructs of the providers and the entire multi-level, multi-tenant hierarchy 300 is tracked by the provisioning platform 318.

The end user devices 308a, 308b may not be aware of the existence of other levels of the hierarchy 300 and/or of the provisioning platform 318.

In an embodiment, the end user devices 308 may not directly interact with one another. All interaction of the end user devices 308 with other end user devices 308 is mediated and governed by the lower-level client device 306.

The end user devices 308a, 308b may not be aware of the existence of other levels of the hierarchy 300 and/or of the provisioning platform 318.

The experience of other tenants of other levels of the hierarchy 300 may be similar to the experience depicted in FIG. 3B. For example, according to their position in the hierarchy 300, tenants more generally may not directly interact with other tenants of the higher and/or the same level. All such interaction may be mediated and/or governed by the provisioning platform 318.

Plugin SDKs may allow the provisioning platform 318 to manage multi-tenancy through the backend of each provider 302, 304. Such plugins may be designed on a contract basis. The plugins may be designed and/or provided by a provider 302, 304, a lower-level client device 306, an end user device 308, an end user, an environment or project 308a, or another party. Accordingly, the plugins represent resource-specific software that implements and abstracts away from core backend platforms. The plugins may advantageously act as “black boxes” for the end user devices 308 and/or the provisioning platform to interact with the providers 302, 304 and obtain the software resources without having to handle details of the interaction, particularly the back end.

In an embodiment, the lower-level client device 306 may define specific environments or projects as tenants 308a, 308b. Such tenants 308a, 308b may further incorporate existing tenants (such as other clients or end user devices) or may define new end user devices 308 at a lower level of the hierarchy 300 (not shown). The environment or project 308a, 308b may be understood as the owner or controller of software resources provided thereto by the provisioning platform 318. Accordingly, even where a user under the environment or project 308a, 308b is removed, the environment or project 308a, 308b may advantageously retain the software resources previously provided thereto.

More generally, each tenant in each level of the hierarchy 300 may be understood as the owner or controller of software resources provided thereto by the provisioning platform 318. Accordingly, even where tenants thereunder are removed, each tenant in each level of the hierarchy 300 may advantageously retain the software resources previously provided thereto.

In an embodiment, only the lowest levels of the hierarchy 300 (e.g., end user devices 308a, 308b) make use of the software resources.

In an embodiment, each tenant in each level of the hierarchy 300 may make use of the software resources.

In an embodiment, end user devices 308 not directly “below” the client device 306 may be granted software resources through the client device 306 in order to participate in or view projects or environments of the client device 306, for example, a different client device 306 or end user device 308 under the different client device 306.

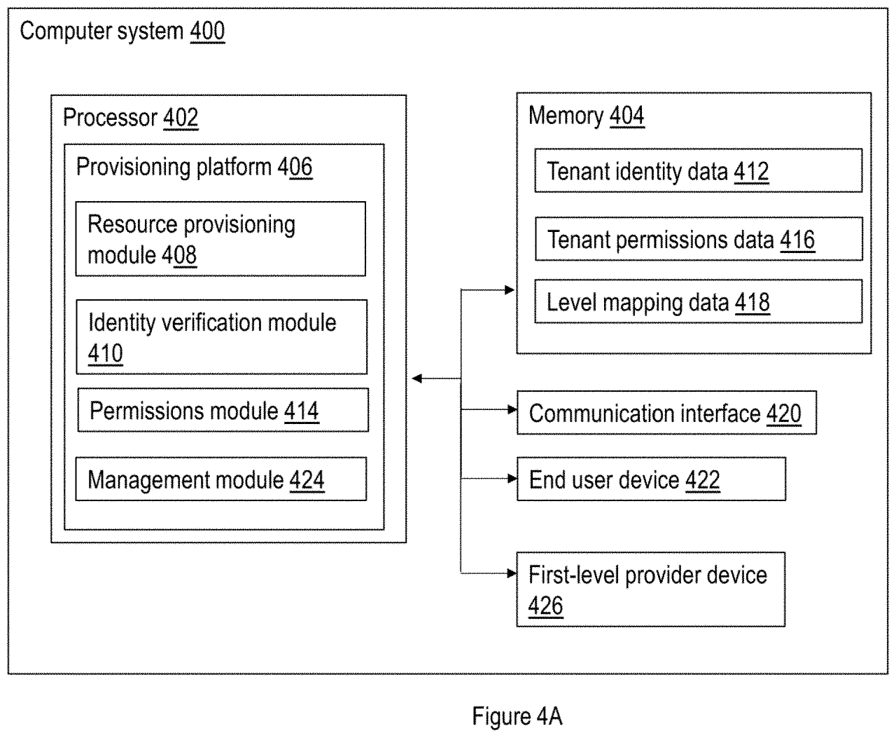

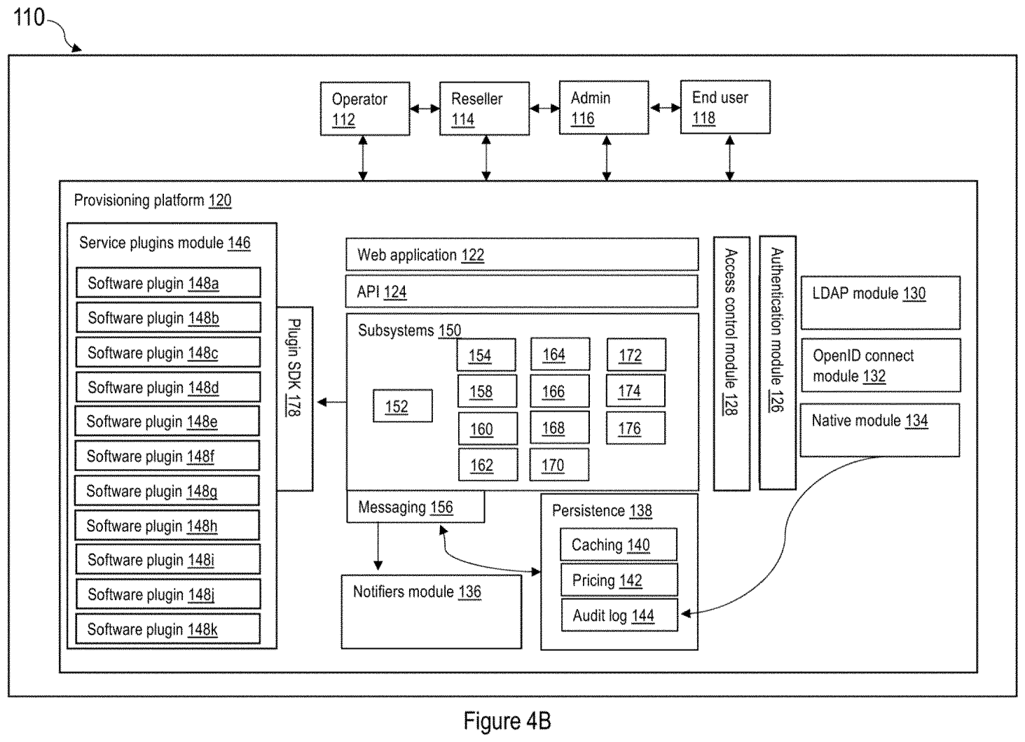

Referring to FIGS. 4A and 4B together, shown therein is a block diagram of a computer system 400 for implementing a multi-level, multi-tenant hierarchy, according to an embodiment. The computer system 400 may be implemented at one or more devices of the system 10 of FIG. 1. For example, components of the computer system 400 may be implemented by any one or more of the providers 12, 22, devices 14, 16, and/or platform 18 of FIG. 1.

The system 400 includes a processor 402 for running the computer system 400 to implement the multi-level, multi-tenant hierarchy 300. The processor 402 includes a provisioning platform 406 for communicating with other components of the computer system 400. Such interfacing may be facilitated by the communication interface 420. The provisioning platform 406 includes a resource provisioning module 408 for provisioning software resources. The provisioning platform 406 includes an identity verification module 410 for verifying identity of tenants. The provisioning platform 406 includes a permissions module 414 for providing the software resource to an end user device according to tenant permissions data 416 and providing the software resource to a user of the end user device according to tenant permissions data 416. The provisioning platform 406 includes a management module 424 for adding, removing, and changing tenants in the hierarchy 300. The management module 424 manages access to the software resources using dynamically generated application programming interfaces (APIs) as enabled by software plugins for connecting the resource provisioning module and a first-level provider device 426.

The system 400 further includes a memory 404 for storing data, including data output from the processor 404. The memory 404 includes tenant identity data 412 for tracking tenant identity. The memory 404 includes tenant permissions data 416 for tracking tenant permissions. The memory 404 includes level mapping data 418 for maintaining a record of relationships between and among tenants and levels.

The system 400 further includes the communication interface 420 for communicating with other devices, such as through receiving and sending data through a network connection (e.g., network 20 of FIG. 1).

The system 400 may further include a display (not shown) for displaying various data generated by the computer system 400 in human-readable format. For example, the display may be configured to display data to which an end user device of the computer system 400 has access.

The resource provisioning module 408 and provisioning platform 406 may provide software resources to tenants according to the tenant permissions data 416 stored in the memory 404. For example, certain end user devices 422 may have access rights to a particular software resource (such as cloud storage or cloud computing), while other end user devices 422 may not. When an end user device 422 attempts to use a software resource through the resource provisioning module 408, the permissions verification module 414 at the processor 402 verifies the permissions of the end user device 422 according to the tenant permissions data 416. Where ownership of data needs to be determined, the identity verification module 410 at the processor 402 verifies the identity of the end user device according to the tenant identity data 412.

In order for the computer system 400 to track and maintain a hierarchy 300 of multiple tenants across multiple levels, level mapping data 418 at the memory 404 maintains a record of relationships between and among tenants and levels, for example, that the end user device 308a is an employee of the lower-level client device 306, which receives software resources from the intermediate-level provider device 304, which ultimately receives software resources from the first-level provider device 426, as in the hierarchy 300 of FIG. 3A.

The processor 402 further includes the management module 424 for adding, removing, and changing tenants in the hierarchy 300. In an embodiment, the management module 424 may further add, alter, or delete the tenant identity data 412, the tenant permissions data 416, and the level mapping data 418.

The computer system 400 for providing software resources includes a provisioning platform 406 for interacting with the first-level provider device 426 in order to gain access to software resources provided by the first-level provider device 426.

The provisioning platform 406 further includes a resource provisioning module 408 for providing the software resources to the end user devices 422.

The provisioning platform 406 further includes a permissions module 414 configured to verify entitlement of an end user device 422 to one or more software resources according to tenant identity data 412 (e.g., an account name), tenant permissions data 416 of the end user device (e.g., a subscription plan), and level mapping data 418 (e.g., a hierarchical mapping of what software resources are provided by what first-level provider devices 426).

The computer system 400 further includes a management module 424 for managing access to the software resources using dynamically generated application programming interfaces (APIs) as enabled by software plugins 148a, 148b, 148c, 148d, 148e, 148f, 148g, 148h, 148i, 148j, 148k (collectively referred to as the software plugins 148) for connecting the provisioning platform 406 and the first-level provider device 426.

The computer system 400 further includes the end user device 422 for interacting with the provisioning platform 408 in order to gain access to the software resource.

In an embodiment, the computer system 400 further includes an intermediate-level provider device (not shown) to which the first-level provider device 426 provides the software resource through the provisioning platform 408 and from which the end user device 422 gains access to the software resource through the provisioning platform 408.

Each end user device 422 may provide respective tenant permissions data 416 for determining whether each user of the end user device 422 may access the software resources.

The resource provisioning module 408 may create an account with the first-level provider device 426.

The end user device 422 may access the software resource through the account created by the resource provisioning module.

The end user device and each user may only access the account with the first-level provider device 426 through the provisioning platform 406.

The resource provisioning module 408 may create a unique account with the first-level provider device 426 for each user of the end user device 422.

The resource provisioning module 408 may use the same account for each user of the end user device 422.

The identity module may be further configured to assign tenant identity data 412 to each user of each end user device 422 specific to the software resource to which the user has access.

The first-level provider 426 device may use the provisioning platform 406 to manage the tenant identity data 412 of each user of each end user device 422.

The first-level provider device 426 may select the software resource provided from among multiple software resources.

Referring now to FIG. 4B, shown therein is a schematic view of a system 110 for accessing and provisioning multiple software resources, according to an embodiment.

The system 110 includes an operator 112 for providing the software resources. The operator 112 may be the first-level provider device 426. In an embodiment, the operator 112 may be a computer device.

The system 110 further includes a reseller 114 for receiving the software resources as provided by the operator 112 and further providing the software resources to an end user device 118 via an admin 116. In an embodiment, the reseller 114 may be the intermediate-level provider device 304. In an embodiment, the reseller 114 may be a computer device.

The system 110 includes the admin 116 for performing functions to maintain and operate the system 110. In an embodiment, the admin 116 may be the lower-level client 306. In an embodiment, the admin may be computer programs. In an embodiment, the admin may be a human operator, such as an employee.

The system 110 further includes the end user device 118 for receiving the software resources. In an embodiment, the end user device 118 may be the end user device 308a, 308b. In an embodiment, the end user device 118 may be a computer device. In an embodiment, the end user device 118 may be used by a human user, such as an employee of a company.

The system 110 further includes the provisioning platform 120 for provisioning the software resources from the operator 112 to the reseller 114 and to the end user device 118. In an embodiment, the provisioning platform 120 may be the provisioning platform 318.

The provisioning platform 120 includes a web application 122 for interacting with the operator 112, the reseller 114, the admin 116, and the end user device 118.

The provisioning platform 120 further includes an API 124 for supporting the web application 122 and facilitating communication between the web application 122 and the operator 112, the reseller 114, the admin 116, and the end user device 118.

The provisioning platform 120 further includes an authentication module 126 for determining and verifying user identity, such as the tenant identity data 412. In an embodiment, the authentication module may use two-factor authentication. In an embodiment, the authentication module 126 may be the identity verification module 410 and/or the permissions module 414.

The provisioning platform 120 further includes a role-based access control module 128 for controlling access to data, software resources, and software resources according to the tenant permission data 416. In an embodiment, the role-based access control module 128 may be the management module 424.

The provisioning platform 120 further includes a lightweight directory access protocol (LDAP) module 130 for directory resources authentication.

The provisioning platform 120 further includes an OpenID Connect module 132 for maintaining user identity (e.g., the tenant identity data 412) across different software resources.

The provisioning platform 120 further includes a native module 134 for executing native software of the software resources.

The provisioning platform 120 further includes a persistence module 138 for maintaining software functionality across software events. The persistence module 138 is in communication with the native module 134. The persistence module includes a caching submodule 140 for storing data and activity of the end user device 118. The persistence module 138 further includes a metrics and pricing submodule 142 for storing information pertaining to usage of the software resources by the end user device 118 and associated pricing information. The persistence module 138 further includes a config and audit log 144 for storing security events involving the end user device 118.

The provisioning platform 120 further includes a notifiers module 136 for receiving notification of software events and propagating the notifications to the operator 112, the reseller 114, the admin 116, and the end user device 118 through the web application 122.

The provisioning platform further includes a service plugins module 146 for communicating with software plugins 148a, 148b, 148c, 148d, 148e, 148f, 148g, 148h, 148i, 148j, and 148k (collectively referred to as the software plugins 148). The service plugins module 146 further includes a plugin SDK 178 for developing software plugins. The SDK 178 includes a well-defined set of interfaces (contracts) so that a subsystems module 150 is able to communicate with the plugins 148.

In an embodiment, the service plugins module 146 may act as the resource provisioning module 408 for interacting with the operator 112 in order to gain access to the software resource provided by the operator 112.

In an embodiment, the service plugins module 146 may act as the management module 424 for managing access to the software resource using the dynamically generated application programming interfaces (APIs) 124 as enabled by the software plugins 148 for connecting the resource provisioning module 408 and the operator 112.

The provisioning platform 120 further includes a subsystems module 150 for performing further functionality.

The subsystems module 150 includes a resources orchestration submodule 152 for communicating with the service plugins module 146 to connect the software resources.

The subsystems module 150 further includes a governance submodule 154 for controlling relationships of modules and submodules of the provisioning platform 120.

The subsystems module 150 further includes a trial management submodule 158 for managing trial periods of new users. The trial management submodule 158 may allow users to register to the web application 120 in a trial mode (e.g., under 30 days). Plugins 148 may define an initial configuration that a new trial user or new trial organization may have. For example, a plugin 148 associated with the trial management submodule 158 may provide a trial user with a network including 3 virtual machines automatically deployed for the trial user.

The subsystems module 150 further includes a multi-tenancy management submodule 160 for managing the tenant identity data 412.

The subsystems module 150 further includes an alerting submodule 162 for communicating with the notifiers module 136 to transmit notification of software events for propagation.

The subsystems module 150 further includes a stream processing and messaging submodule 156 for communicating with the persistence module 138.

The subsystems module 150 further includes a reports submodule 164 for compiling reports on the provisioning platform 120.

The subsystems module 150 further includes a metrics submodule 166 for compiling metrics on the provisioning platform 120.

The subsystems module 150 further includes a branding submodule 168 for storing branding information of the provisioning platform 120.

The subsystems module 150 further includes a logging submodule 170 for logging system usage and/or errors. The logging submodule 170 may advantageously provide an indication of what is happening in the web application 122 in order to troubleshoot any issues that may arise in the system 110 or any subsystem or part thereof. Logs generated by the logging submodule 170 may be pushed to an external system (e.g., Elasticsearch+Kibana).

The subsystems module 150 further includes a monetization submodule 172 for monetizing the software resources according to usage. the monetization submodule 172 may advantageously allow a reseller 114 to charge customers based on customer usage. Such customers may be the end user 118. A reseller 114 may define its own products based on resources that a plugin 148 exposes. A reseller 114 is not limited to reselling existing resources as such and may flexibly define products based on multiple software resources in ways not yet considered by the plugins 148. Advantageously, the plugins 148 may include interfaces that return usage records to enable pricing of products and resources based on the definitions provided by the reseller 114.

The subsystems module 150 further includes a security submodule 174 for controlling access to the provisioning platform 120.

The subsystems module 150 further includes a content management submodule 176 for managing content on the provisioning platform 120. The content management submodule 176 may advantageously permit the reseller 114 to write its own branding, notification, and documentation specific to products of the reseller 114 and deployment thereof.

Data indicated as transmitted through arrows shown in FIG. 4B may include the software resources. Specifically, data indicated as transmitted via arrows associated with 112, 114, 116, and 118 include API calls (made by the API 124) using an HTTP protocol and JSON as the format. Such API calls may be representative of a rest API. Furthermore, data indicated as transmitted via arrows 120 represent function calls within the web application 122 itself and may include data from the user request and data stored in the persistence module 138.

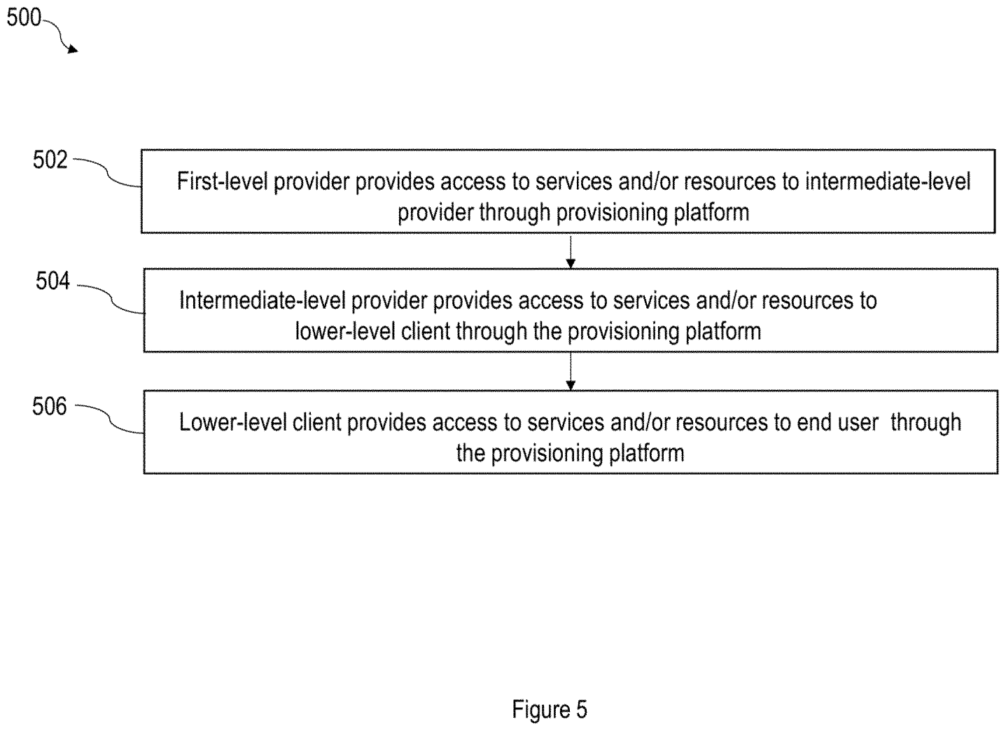

Referring now to FIG. 5, shown therein is a flow chart of a method 500 for providing software resources, according to an embodiment.

At 502, a first-level provider device 302 provides software resources to an intermediate-level provider device 304 through a provisioning platform 318.

At 504, the intermediate-level provider device provides software resources to a lower-level client device 306 through the provisioning platform 318.

At 506, the lower-level client device 306 provides software resources to an end user device 308 through the provisioning platform 318.

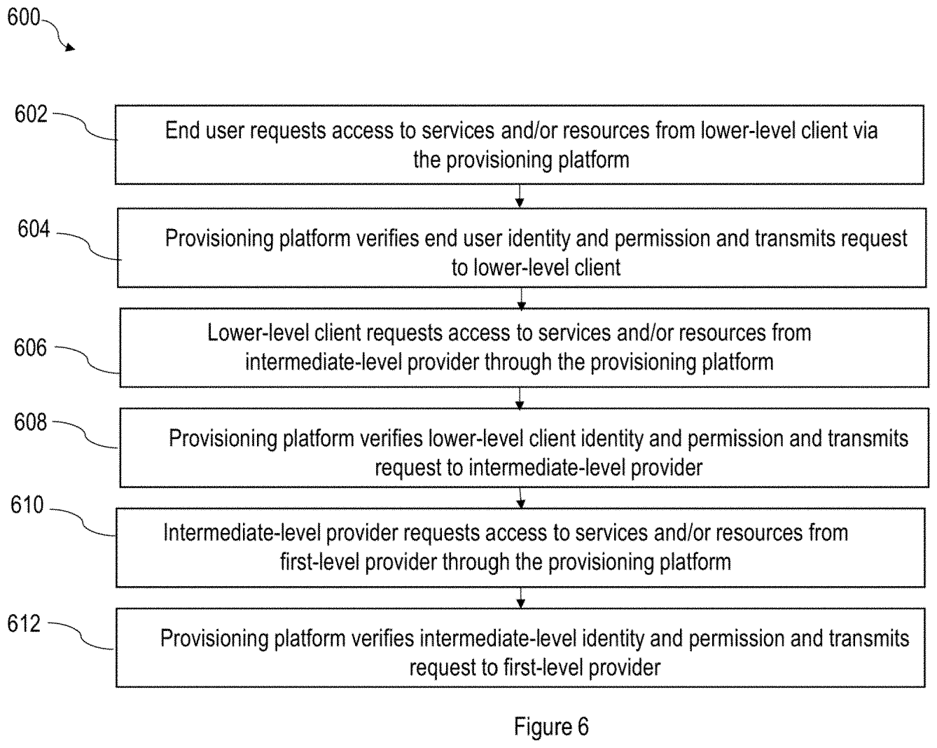

Referring now to FIG. 6, shown therein is a flow chart of a method 600 for providing software resources, according to an embodiment.

At 602, an end user device 308 requests resources from a lower-level client device 306 through a provisioning platform 318.

At 604, the provisioning platform 318 verifies tenant identity data 412 and tenant permissions data 416 of the end user device 308 and transmits the request to the lower-level client device 306.

At 606, the lower-level client device 306 requests resources from an intermediate-level provider device 304 through the provisioning platform 318.

At 608, the provisioning platform 318 verifies tenant identity data 412 and tenant permissions data 416 of the lower-level client device 306 and transmits the request to the intermediate-level provider device 304.

At 610, the intermediate-level provider device 304 requests resources from a first-level provider device 302 through the provisioning platform 318.

At 612, the provisioning platform 318 verifies tenant identity data 412 and tenant permissions data 416 of the intermediate-level provider device 304 and transmits the request to the first-level provider device 302.

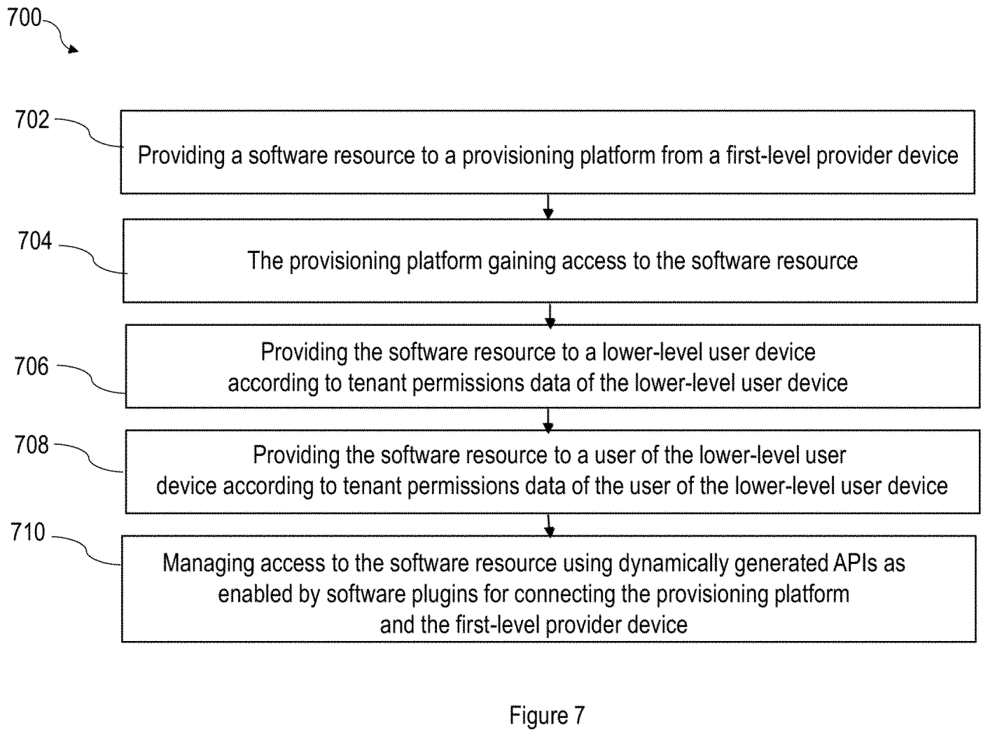

Referring to FIG. 7, shown therein is a flow chart of a method 700 for providing software resources, according to an embodiment.

At 702, providing a software resource to a provisioning platform 318 from a first-level provider device 302.

At 704, the provisioning platform 318 gaining access to the software resource.

At 706, providing the software resource to an end user device 308 according to tenant permissions data 416 of the end user device 306.

At 708, providing the software resource to a user of the end user device 308 according to tenant permissions data 416 of the user of the end user device 308.

At 710, managing access to the software resource using dynamically generated APIs 124 as enabled by software plugins 148 for connecting the provisioning platform 318 and the first-level provider device 302.

The systems, methods, and devices disclosed herein may advantageously monitor use of the software resources to facilitate tracking and data collection.

The systems, methods, and devices disclosed herein may advantageously allow auto-scalability in order to integrate further software resources among further levels and/or tenants. Auto-scalability represents the ability of the systems, methods, and devices to automatically dynamically adjust available software resources proportional to the load on the systems, methods, and devices. More specifically, auto-scalability permits adding rules to automatically add or remove resources according to specific metrics, e.g., CPU usage, RAM usage.

The systems, methods, and devices disclosed herein may serve as a source of truth resources, i.e., may aggregate all relevant and correct data in a single place to be made available as needed and according to permissions. The source of truth resources may further include backend services to which the web application 122 is connected.

In a high-volume consumption of software resources, subaccounts may be created to more efficiently manage software resources and provision of same. For example, resources may be separated into logic blocks, e.g., one environment for a dev system and another for production.

The tenant identity data 412 and/or tenant permissions data 416 may allow the systems, methods, and devices disclosed herein to be used as identity providers for external software resource providers just as the provisioning platform 318 may use the data 412, 416 to verify identity and/or permissions within the system 10.

The provisioning platform 318 may create new providers and/or software resources by mapping existing providers and/or software resources in new combinations and subcombinations and/or creating custom fields for users and/or organizations.

In order to avoid collisions (e.g., name collisions), each software resource may be provided one at a time within the provisioning platform 318. By tagging each software resource with respect to an organization providing the software resource, advantageously no two organizations or software resources thereof may have the same representation, and a flat collection of projects may advantageously be created.

The provisioning platform 318 may advantageously map the providers 302, 304, clients 306, and/or end user devices 308 provided with respect to a software resource to the roles associated with that software resource in the original provider thereof (e.g., the first-level provider device 302), e.g., owner of an account supported by the original provider thereof.

In an embodiment, the provisioning platform 318 further supports identity and audit tracing and audit logging. Audit tracing and audit logging may allow for reconstruction of activities via the systems, methods, device, for example in case of illegal access to software resources. Audit tracing represents a log of user interaction on the web application 122 and may provide context of what was submitted and the result of this action.

Accordingly, the provisioning platform 318 may facilitate the integration of software resources by providers 302, 304 that do not offer accounts to regulate ownership, control, and usage of the software resources and data provided therefrom and/or thereto. Advantageously, the providers 302 may offer wall garden experiences to other providers 304, clients 306, and end user devices 308, i.e., the hierarchy 300 is a closed ecosystem, and all operations are controlled by the provisioning platform 318.

In an embodiment, the provisioning platform 318 is responsible for provisioning software resources. Once provided, the software resources are no longer in the critical path.

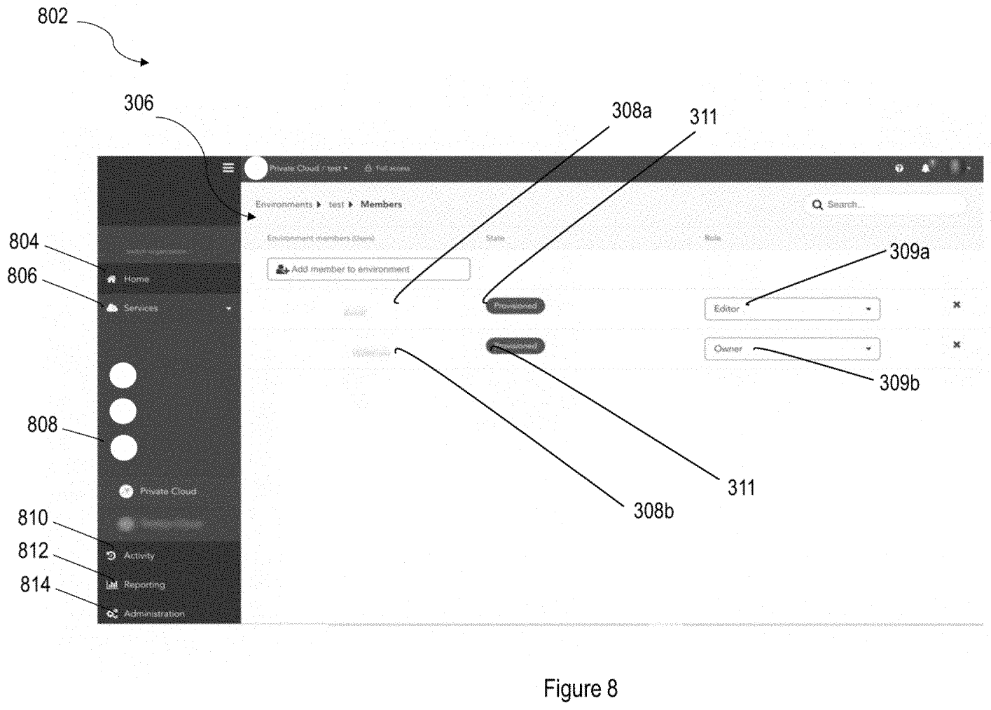

Referring now to FIG. 8, shown therein is an environment 802 to which software resources are provided.

The environment 802 may be considered the owner or controller of some or all of the software resources so provided. In an embodiment, the environment 802 may be a computer domain, a network, or a project. When the environment 802 is created, the web application 122 stores information about to which backend resource the environment 802 is connected to and what credentials to use when interacting with the backend resource. The web application 122 becomes the “owner” of that resource as the we application 122 manages the lifecycle of the resource and allows users to access the environment 802 by doing calls on their behalf with their credentials.

The environment 802 includes a “home” panel 804 for directing a user of an end user device 308 to a home page of the environment 802.

The environment 802 further includes a services panel 806 for directing the user to an overview of software resources or “services” available to the environment 802.

The environment 802 further includes an object storage panel 808 within the services panel 806 for specifically directing the user to available object storage, which may be provided as a software resource available within the services panel 806.

The services and particularly the object storage available to a user 308 through the panels 806, 808, may vary according to a user's credentials 309.

The lower-level client device 306 has access to the environment 802. Users 308a, 308b under the lower-level client device 306 receive the software resources in order to perform tasks, for example, writing software.

Each user 308 has a status 311 within the environment 802 for indicating whether the user 308 has access to any of the software resources of the environment 802. In the environment 802, each user 308 has the status 311 of “provided”, indicating that access to the software resources of the environment 802 is so available.

The environment 802 further includes the credentials 309 specific to each user 308.

The user 308a has credentials 309a of “editor”, which grants the user 308a the ability to access all the software resources of the environment 802. The credentials 309a further grant the user 308a the rights to view and modify any data of the environment 802.

The user 308b has credentials 309b of “viewer”, which grants the user 308b the ability to access only some of the software resources of the environment 802. The credentials 309b further grant the user 308b the rights to view but not to modify the data of the environment 802.

The environment 802 further includes an activity panel 810 for providing an overview of user activity. Depending on a user's credentials 309, different activity data may be made available to the user through the activity panel 810. For example, where the user 308a has the “editor” credential 309a, the user 308a may be able to view the activity data of all users 308 within the environment 802. Where the user 308b has the “viewer” credential 309b, the user 308b may only be able to view the activity data of the user 308b within the environment 802.

The environment 802 further includes a reporting panel 812 for providing reports of software resource usage within the environment 802. Depending on a user's credentials 309, different reporting data may be made available to the user through the activity panel 810. For example, where the user 308a has the “editor” credential 309a, the user 308a may be able to view the reporting data pertinent to all users 308 within the environment 802. Where the user 308b has the “viewer” credential 309b, the user 308b may only be able to view the reporting data pertinent to the user 308b within the environment 802.

Each of the users 308 may be understood as members of the environment 802. The credentials 309 determine the ability of each user 308 to access some or all the software resources allocated to the environment 802, for example object storage. Accordingly, the credentials 309 may determine the ability of each user 308 to access some or all the data stored by object storage of the environment 802.

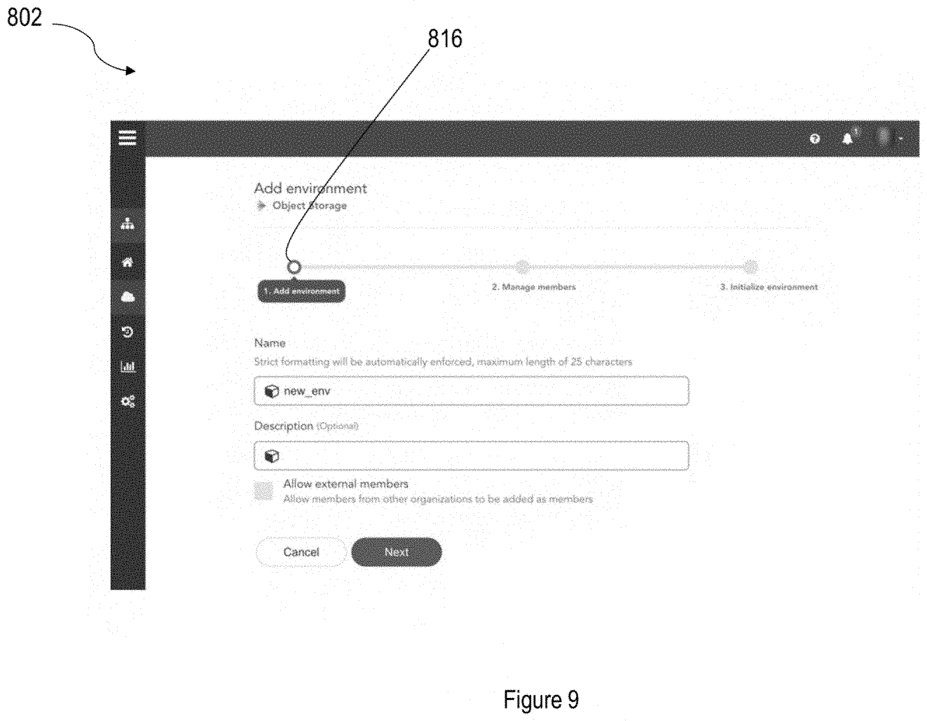

Referring now to FIG. 9, shown therein is a view of the environment 802 during a first step 816 of adding the environment 802 to the hierarchy 300. The environment 802 may be understood as a part of a provisioning platform 318 in FIG. 3.

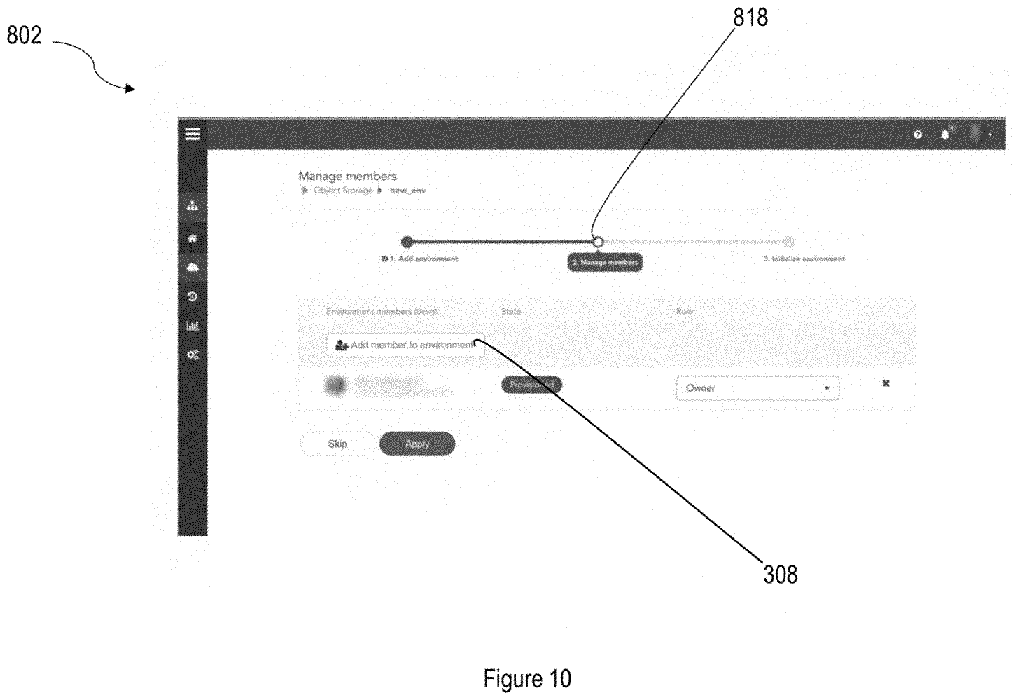

Referring now to FIG. 10, shown therein is a view of the environment 802 at a second step 818 of adding additional users 308 to the environment 802.

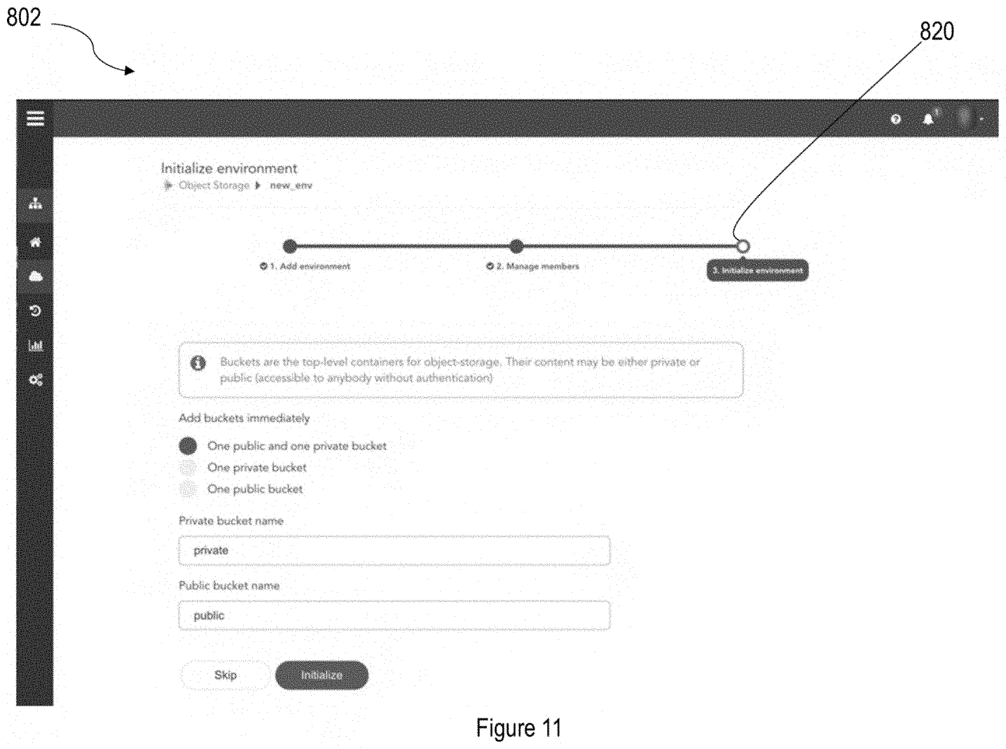

Referring now to FIG. 11, shown therein is a view of the environment 802 at a third step 820 of providing tenant identity data 412 and tenant permissions data 416 in order to specify to what data each end user device 308 is to have access to view and/or modify and/or to what software resources each end user device 308 is to have access.

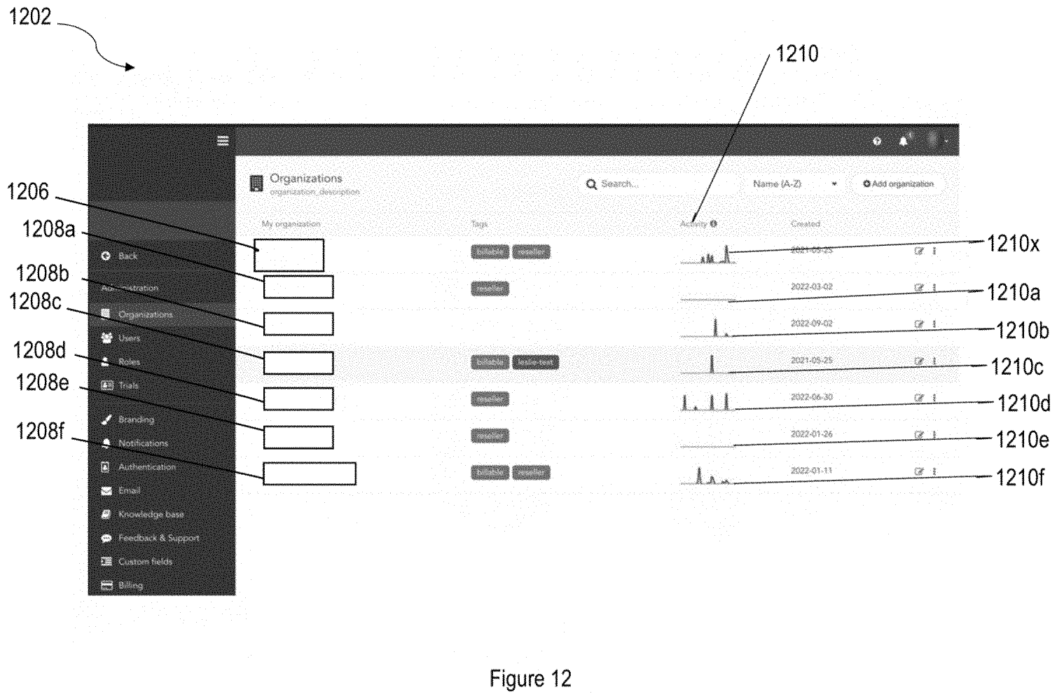

Referring now to FIG. 12, shown therein is a view 1202 of the organizational structure of a lower-level client device 1206 of the multi-level, multi-tenant hierarchy 300. The lower-level client device 1206 provides software resources to further lower-level client devices 1208a, 1208b, 1208c, 1208d, 1208e, 1208f (collectively referred to as the further lower-level client device 1208) “below” the lower-level client device 1206 in the hierarchy 300. The further lower-level client devices 1208 act as resellers of the software resources to further “lower” levels on the hierarchy 300.

The view 1202 includes activity data 1210 showing the activity of the lower-level client device 1206 and the further lower-level client devices 1208 with respect to the software resources. The activity data 1210 represents a number of “activity” logs (e.g., login, create/delete/update resource, modifying state in the system) automatically generated by end users, such as the end users 118 in FIG. 4B.

For example, activity data 1210x corresponds to the activity of the lower-level client device 1206, activity data 1210a corresponds to the activity of the further lower-level client device 1208a, activity data 1210b corresponds to the activity of the lower-level client device 1208b, activity data 1210c corresponds to the activity of the lower-level client device 1208c, activity data 1210d corresponds to the activity of the lower-level client device 1208d, activity data 1210e corresponds to the activity of the lower-level client device 1208e, and activity data 1210f corresponds to the activity of the lower-level client device 1208f.

In an embodiment, no tenant or level (such as the lower-level client device 1206, the further lower-level client devices 1208) may view any part of a level “higher” on the hierarchy 300.

In an embodiment, the hierarchy 300 may be implemented on a virtual machine.

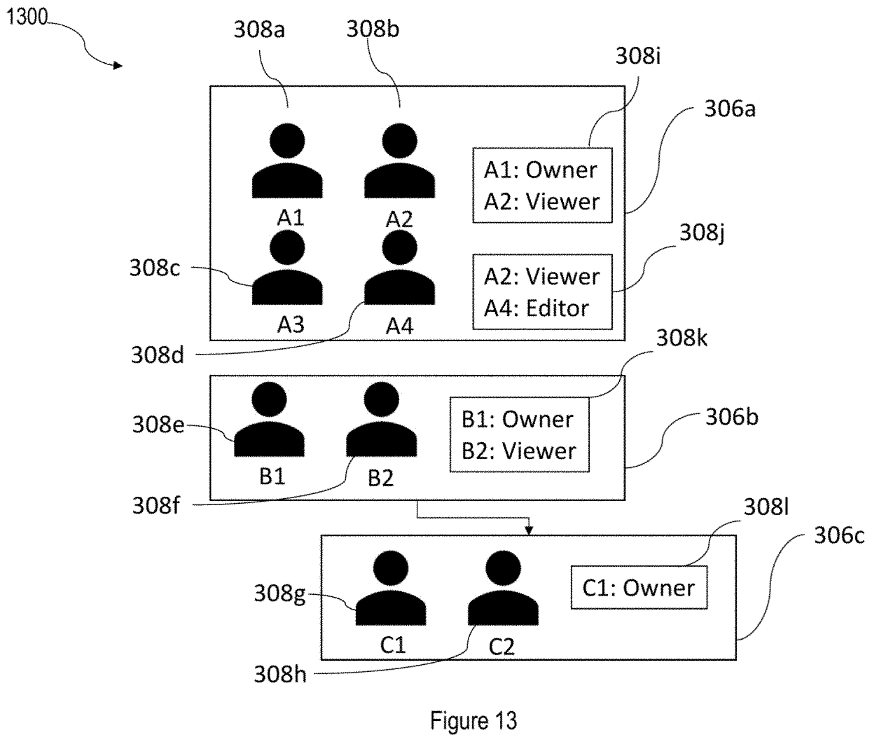

Referring now to FIG. 13, shown therein is a chart 1300 of an organizational structure of several lower-level client devices 306a, 306b, 306c.

The lower-level client device 306a includes users 308a, 308b, 308c, and 308d.

The lower-level client device 306a further includes an environment 308i owned by the user 308a and viewable by the user 308b. The user 308a may have full permission to add, alter, or delete data within the environment 308i. The user 308b may have permission to view but not to add, alter, or delete data within the environment 308i.

The lower-level client device 306a further includes an environment 308j viewable by the user 308b and editable by the user 308d. The user 308b may have permission to view but not to add, alter, or delete data within the environment 308j. The user 308d may have permission to view and alter but not to add or delete data within the environment 308j.

The lower-level client device 306b includes users 308e, 308f.

The lower-level client device 306b includes an environment 308k owned by the user 308e and viewable by the user 308f. The user 308e may have full permission to add, alter, or delete data within the environment 308k. The user 308f may have permission to view but not to add, alter, or delete data within the environment 308k.

The lower-level client device 306c includes users 308g, 308h.

The lower-level client device 306c includes an environment 308l owned by the user 308g. The user 308g may have full permission to add, alter, or delete data within the environment 308l.

Because the lower-level client device 306c is organizationally beneath the lower-level client device 306b, the lower-level client device 306b may be able to view and/or alter any data of the lower-level client device 306c. Whether particular users of the lower-level client device 306b have permission to view, add, alter, or delete data of particular users 308 or tenants 308 of the lower-level client device 306c may depend on the permissions granted and the relationship between the lower-level client device 306b and the lower-level client device 306c.

An environment 308 may be deemed provisioned when the environment 308 has been provided with access to software resources. An environment 308 may be deemed not provisioned when the environment 308 has not been provided with access to software resources.

Similarly, a user 308a of an environment 308b may be deemed provisioned with respect to the environment 308b when the user 308a has been provided with access to software resources of the environment 308b. Similarly, a user 308a of an environment 308b may be deemed not provisioned with respect to the environment 308b when the user 308a has not been provided with access to software resources of the environment 308b.

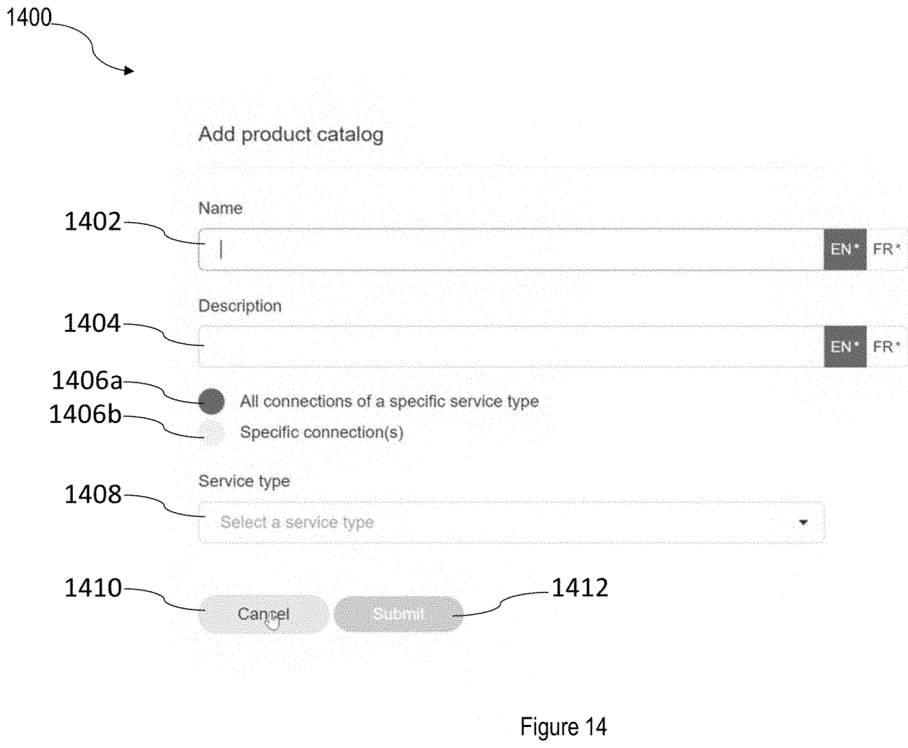

Referring now to FIG. 14, shown therein is a view 1400 of the provision of software resources.

At input 1402, a provider device 12, 22 selects a name for the software resources to be provided.

At input 1404, the provider device 12, 22 inputs a description for the software resources to be provided. The description may be optional.

At input 1406, the provider device 12, 22 selects whether the software resources are to include all connections of a specific service type as options 1406a or only specific connection(s) as option 1406b.

At input 1408, the provider device 12, 22 selects a service type.

At input 1410, the provider device 12, 22 may cancel the provision of the software resources.

At input 1412, the provider device 12, 22 may submit the provision of the software resources. Submitting the provision of the software resources as at input 1412 may make the software resources available as in system 10.

Provided is a cloud services platform that is multi-level, allows multi-tenancy, offers end-user interaction, multiple service access through a single platform, auto-scalability, and monitoring usage through plugin SDK. The cloud services platform allows managing resources through dynamically generated APIs as enabled by software plugins, SDKs, and/or plugin SDKs.

While the above description provides examples of one or more apparatus, methods, or systems, it will be appreciated that other apparatus, methods, or systems may be within the scope of the claims as interpreted by one of skill in the art.

1. A system for providing software resources, the system comprising:
a first-level provider device that provides a software resource;
a provisioning platform comprising:
a resource provisioning module for interacting with the first-level provider device in order to gain access to the software resource;
a permissions module configured to:
provide the software resource to an end user device according to tenant permissions data of the end user device; and
provide the software resource to a user of the end user device according to tenant permissions data of the user of the end user device; and
a management module for managing access to the software resource using dynamically generated application programming interfaces (APIs) as enabled by software plugins for connecting the resource provisioning module and the first-level provider device; and
the end user device for interacting with the provisioning platform in order to gain access to the software resource.

2. The system of claim 1 further comprising an intermediate-level provider device to which the first-level provider device provides the software resource through the provisioning platform and from which the end user device gains access to the software resource through the provisioning platform.

3. The system of claim 1, wherein each end user device provides tenant permissions data for determining whether each user of the end user device may access the data.

4. The system of claim 1, wherein the resource provisioning module creates an account with the first-level provider device.

5. The system of claim 1 further comprising an identity module for assigning tenant identity data to each user of each end user device specific to the software resource to which the user has access.

6. The system of claim 5, wherein the first-level provider device uses the provisioning platform to manage the tenant identity data of each user of each end user device.

7. The system of claim 6, wherein the first-level provider device selects the software resource from among multiple software resources.

8. A method for providing software resources, the method comprising:
providing a software resource from a first-level provider device;
a provisioning platform gaining access to the software resource through the first-level provider device;
providing the software resource to an end user device according to tenant permissions data of the end user device;
providing the software resource to a user of the end user device according to tenant permissions data of the user of the end user device; and
managing access to the software resource using dynamically generated APIs as enabled by software plugins for connecting the provisioning platform and the first-level provider device.

9. The method of claim 8 further comprising the permissions module providing the software resource from the first first-level provider device to an intermediate-level provider device and from the intermediate-level provider device to the end user device.

10. The method of claim 8 further comprising providing tenant permissions data for determining whether each user of the end user device may access the data.

11. The method of claim 8 further comprising assigning tenant identity data to each user of each end user device specific to the software resource to which the user has access.

12. The method of claim 11 further comprising managing the tenant identity data of each user of each end user device.

13. The method of claim 8 further comprising selecting the software resource from among multiple software resources.

14. A provisioning platform for providing software resources, the platform comprising:
a resource provisioning module for interacting with a first-level provider device in order to gain access to the software resource;
a permissions module configured to:
provide the software resource to an end user device according to tenant permissions data of the end user device; and
provide the software resource to a user of the end user device according to tenant permissions data of the user of the end user device; and
a management module for managing resources using dynamically generated application programming interfaces (APIs) as enabled by software plugins for connecting the resource provisioning module and the first-level provider device.

15. The platform of claim 14, wherein the resource provisioning module provides the software resource from the first-level provider device to an intermediate-level provider device and from the intermediate-level provider device to the end user device.

16. The platform of claim 14, wherein each end user device provides tenant permissions data for determining whether each user of the end user device may access the data.

17. The platform of claim 14, wherein the resource provisioning module creates an account with the first-level provider device.

18. The platform of claim 14 further comprising an identity module for assigning tenant identity data to each user of each end user device specific to the software resource to which the user has access.

19. The platform of claim 18, wherein the first-level provider device uses the provisioning platform to manage the tenant identity data of each user of each end user device.

20. The platform of claim 14, wherein the first-level provider device selects the software resource from among multiple software resources.
